(19) United States
(12) Patent Application Publication
(10) Pub. No.: US 2012/0177862 A1
(43) Pub. Date: Jul. 12, 2012

(54) ENGINEERED BOARD, AND METHOD OF MANUFACTURING SAME

(75) Inventor: Denis Girard, Quebec (CA)

(73) Assignee: PRODUITS FORESTIERS CANBO, INC., Dolbeau (Quebec) (CA)

(21) Appl. No.: 13/038,998

(22) Filed: Mar. 2, 2011

(30) Foreign Application Priority Data
Jan. 12, 2011 (CA) 2723218

(51) Int. Cl. B32B 21/13; B27M 1/08

(52) U.S. Cl. 428/58; 144/350

(57) ABSTRACT

The engineered board can be produced with spruce wood at moisture contents at or below 8%, while maintaining knot-fallout resistance which allows uses such as cabinet work products. The process can involve adhering a plurality of dimensional lumber boards face to face into a stacked assembly, in a direction perpendicular to the average growth ring direction and parallel to the average knot direction, and then sawing engineered boards from the stacked assembly by sawing.

### BACKGROUND OF THE INVENTION

Formerly, engineered boards for use in cabinetwork such as wood cabinets, shelves, furniture, and the like, were only industrially manufactured in North America from specialized essences of wood. In cases of low-density wood (softwood), pine such as Eastern white pine was commonly used, which is a relatively rare and expensive essence of wood when compared to the more common Black spruce for instance, thereby imparting a relatively high price to the end-use engineered board product.

One of the reasons this was so is the fact that the wood used in cabinet work is dried down to a relatively low moisture content compared to dimensional lumber which can typically be used between 15 and 18% moisture content. As it ages, wood typically dries, which imparts side effects such as warping. Drying imparted deformation is acceptable to a certain extent in rough dimensional lumber applications. However, tolerance to drying imparted deformation is much lower for finer applications such as cabinet work. For this reason, cabinet work wood of soft essences is typically dried to or below 12% moisture content, and preferably to or below 8% moisture content prior to use, which represents a moisture content significantly less than typical dimensional lumber applications.

However, the reduction of the moisture content can also affect the strength of the natural bond which holds the knots to the body of the wood. In the case of spruce for instance, the former common general knowledge in the field indicated that drying it to cabinet-work-acceptable moisture contents would break the natural adhesion between the body of the wood and the knots in such a manner that it renders it unworkable for finer applications. This explains the former paradigm to the effect that spruce was not an option considered for cabinetwork. Pine was not known as being prone to such fallbacks upon drying to cabinet work moisture contents. Pine thus continued to be used in cabinetwork, and other lower humidity applications, notwithstanding its higher price and rareness.

There thus remained a need for engineered boards at a lesser price or better availability.

### SUMMARY OF THE INVENTION

It was discovered that in an engineered cabinetwork lumber, the limits of spruce in terms of knot stability can be significantly overcome by adhering spruce lumber face to face in a direction perpendicular to the average direction of the growth rings. In fact, due to common harvesting and transformation processes, in the majority of cases the width of lumber is in greater alignment with the direction of the growth rings than with the averagely perpendicular direction of the branches and knots. Therefore, a majority of the knots tend to extend transversally across the faces, and therefore most have at least one end exposed on the faces. It was found that adhering face to face at relatively low moisture contents allowed the adhesive to penetrate into the lumber around the knots via the exposed ends thereof on the faces. The adhesive can thus compensate for knot weakness characteristic of essences such as Black spruce at low moisture contents, which in turn, allows the use of such essences in engineered boards for cabinetwork. When using Black spruce for instance, the engineered wood board so obtained can now be provided at a lower cost than former pine products due to the lesser costs and greater availability of the base material.

Further, it was also found that engineered boards made from face-to-face adhered lumber, instead of from side-to-side adhered lumber which was formerly used, can allow to generate appealing and original visual features, when obtaining the engineered boards from sawing the stack in the direction perpendicular to the adhered faces.

[Henceforth, the engineered board can be produced with spruce wood at moisture contents at or below 8%, while maintaining knot-fallout resistance which allows cabinet work usage. The process can involve adhering a plurality of dimensional lumber boards face to face into a stacked assembly, in a direction perpendicular to the average growth ring direction and parallel to the average knot direction, and then sawing engineered boards from the stacked assembly by sawing.

In accordance with one aspect, there is provided a process of making engineered boards of spruce wood, the process comprising: obtaining a plurality of lumber boards of spruce wood having same dimensions, each of said lumber boards having a length greater than a width, and the width greater than a thickness, the thickness extending between two faces, and a moisture content equal to or below a threshold moisture content of 12%, the thickness of the lumber boards on average extending in a direction perpendicular to an average growth ring direction and parallel to an average knot direction; adhering the lumber boards face to face into a stack having a thickness corresponding to the width of the lumber boards; obtaining engineered boards of spruce wood by sawing the stack.

In accordance with another aspect, there is provided an engineered board having a length greater than a width, and a width greater than a thickness, including a plurality of individual pieces of lumber each having the thickness of the engineered board and adhered to one in a direction of the width of the engineered board into a stack, the engineered board being CHARACTERIZED IN THAT the direction of the width of the engineered board is perpendicular to an average growth ring direction and parallel to an average knot direction.

Many further features and combinations thereof concerning the present improvements will appear to those skilled in the art following a reading of the instant disclosure.

It will be noted here that moisture content in % as used in this specification can be understood in the traditional sense, that is: to correspond to the weight of “wet” wood, minus the weight of dry wood, divided by the weight of dry wood, times one hundred.

### BRIEF DESCRIPTION OF THE DRAWINGS

In the figures,

FIG. 1 is a cross-sectional view of a tree, schematically showing the cross-section shapes of exemplary dimensional lumber;

FIG. 2 is an oblique view of a dimensional lumber board obtained from a tree as shown in FIG. 1;

FIG. 3 is an oblique view of a plurality of lumber boards such as shown in FIG. 2 adhered face to face into a stack; and

FIG. 4 is an oblique view of an engineered wood board obtained by sawing transversally across the stack shown in FIG. 3.

### DETAILED DESCRIPTION OF THE PREFERRED EMBODIMENTS

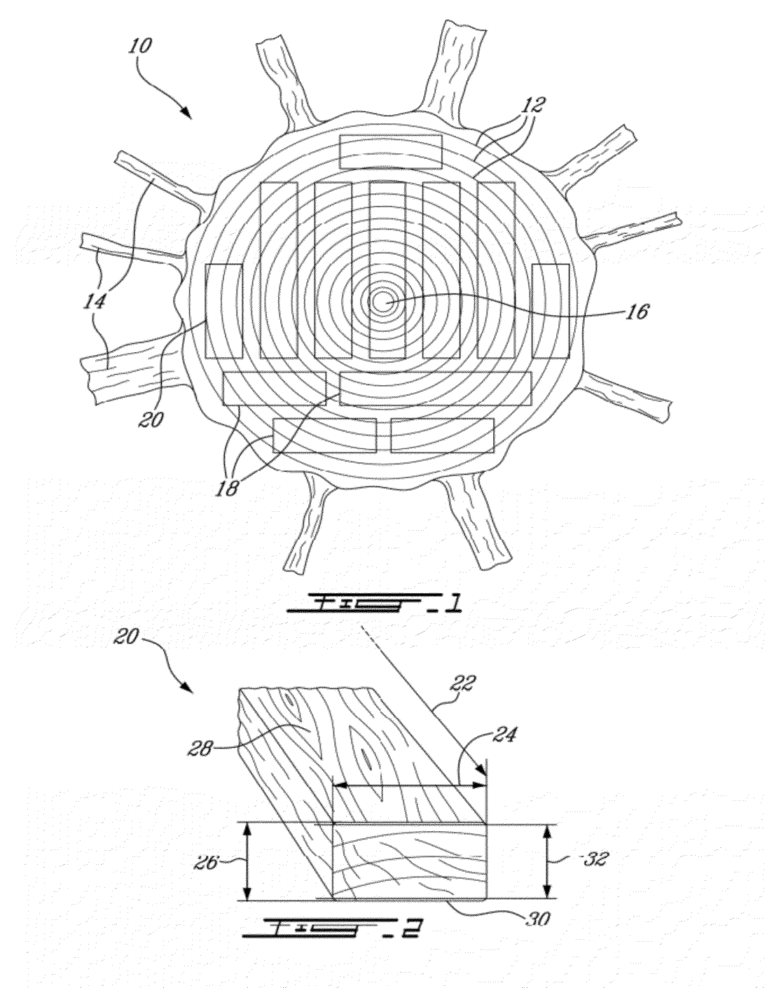

FIG. 1 shows a cross-section of an example of a softwood tree 10. The tree 10 has a plurality of concentric growth rings 12 which occur naturally given the growth of the tree over the years and during different seasons. These growth rings 12 typically have a closed loop shape which roughly corresponds to the outer shape of the tree though at different scales. They are normally at least somewhat circular in shape and can be said to extend around a core 16 of the trunk of the tree 10. The softwood tree 10 also has a plurality of branches 14 which generally extend in a direction at least roughly perpendicular to the growth rings.

In the industry of lumber, given sizes lumber are attributed corresponding values. When a tree is harvested, care is taken to optimize the amount of value which can be obtained from the given tree. This typically implies closely fitting dimensional lumber sizes as a function of the particular geometry of the tree, in a given pattern. Such a pattern 18 including two different dimensional lumber sizes is schematized in FIG. 1. The branches which are perpendicular to the growth rings on average, extend along a certain distance internally into the tree trunk, which causes knots in the lumber. Given the fact that the dimensional lumber have rectangular cross-sections and need to be fit inside an often roughly circular tree trunk shape, the pattern 18 often results in the width of the individual dimensional lumber such as dimensional lumber 20 being at least roughly aligned with the growth rings 12 on average, and the extensions of the branches (that is the knots) have a tendancy to cross the thickness of the dimensional lumber 20. In other words, given the average orientation of the branches 14 and of the dimensional lumber pattern 18 cross-section, these knots occur significantly more often in a direction across the thickness of the dimensional lumber, rather than across the width, for instance. Henceforth, the knots in dimensional lumber are mostly exposed on the faces, in a proportion of the order of 80% in the case of Black spruce for instance.

As will be detailed below, the method of making an engineered wood board taught herein involves adhering lumber boards face to face, which provides for an elevated ratio of knots being exposed to the adhesive and to the interface between adjacent lumber boards. It was found that this can overcome and solve problems formerly associated to using essences of wood such as spruce in applications such as most cabinet work which require a relatively high integrity of wood at relatively low moisture content levels.

### Example

When dimensional lumber are delivered, they are typically at a relatively high moisture content, perhaps between 15 and 18%. Before being assembled into a stack, they are dried down to a moisture content acceptable in view of the application. This moisture content can be 12, 10, or 8% for example, or even lower. More specifically, the dimensional lumber can be kilned, and their moisture content monitored. If they are not sufficiently dry, they can be rejected and returned to the kiln for further wood drying prior to use in the process.

In this example, the dimensional lumber can consist of “two by four” boards of Black spruce for instance. Other standard or non-standard dimensions can also be used. An example of a two by four board 20 is shown in FIG. 2. The two by four board 20 can be understood to have a length 22 greater than its width 24, and a width 24 greater than its thickness 26. The two faces 28, 30 of the board 20 extend along the length 22 and width 24, on opposite sides of the board thickness 26. Prior to stacking, the dimensional lumber can be planed to prepare the two faces for adhesion. The dimensional lumber can be planed from an initial thickness dimension 26 to a planed thickness dimension 32. In the case of a two by four, the boards 20 can be planed from 1.5 inches thickness (3.8 cm) down to 1.4 inches thickness (3.6 cm), for example, and thereby remove rounded edges on both sides. In this example, planing is done subsequently to drying.

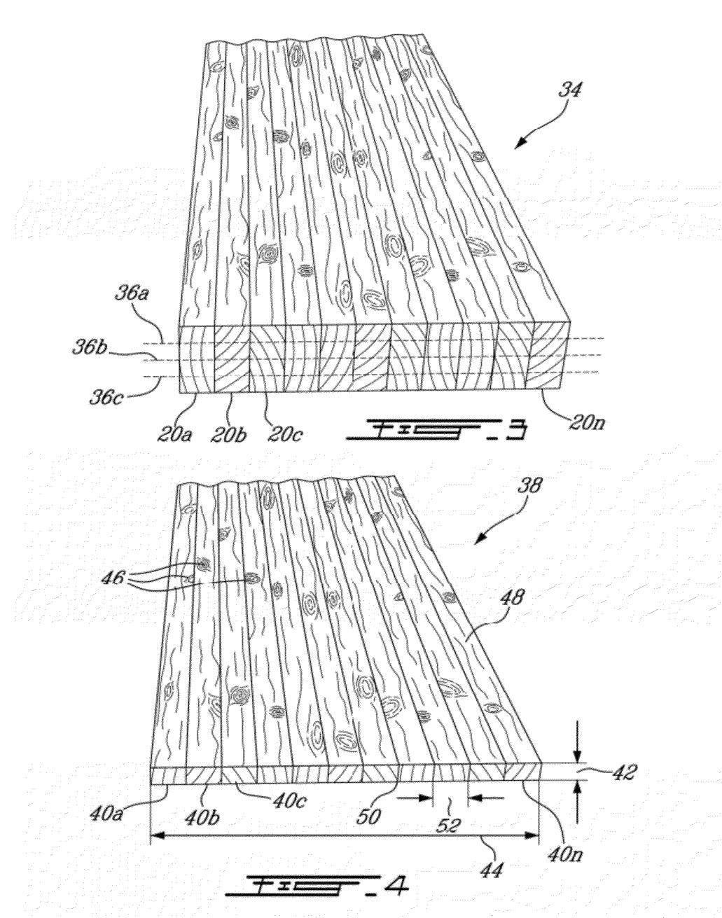

Turning to FIG. 3, a number of dimensional lumber boards 20a, 20b, 20c . . . 20n, which have previously preferably been dried to an acceptable moisture content and planed, are coated with adhesive between the faces and stacked face to face against one another into a stack 34. The wood adhesive used can be Wonderbond® XB-90K5-LF cross-linking emulsion catalyzed with a suitable Wonderbond® hardener, for instance, which are manufactured by Hexion™ Specialty Chemicals, and which have provided satisfactory results.

In this example, with the adhesive applied between the faces, to an amount of 5% by weight of the final product, an average pressure of 120 lbs/po2 (827 kPa) can be applied and maintained at 175° F. (79° C.) for 30 minutes to achieve satisfactory results. This can be achieved by applying 150 lbs/po2 (1030 kPa) pressure at each 4 inches (10 cm) along the length of the boards, for instance. The penetration of the adhesive around the knots was such that in some cases protuberances of adhesive appeared at exposed knot ends for knots which had an other end exposed to the adhesive, the adhesive having traveled around the knot across the thickness of the lumber.

Once the stack is adhered, engineered wood boards can be obtained by sawing across the thickness of the individual boards in the stack for instance. In this example, this is done along the dotted lines 36a, 36b, 36c shown in FIG. 3, to obtain a cabinet work product 38 including a plurality of individual pieces of lumber 40a, 40b, 40c . . . 40n each having a width corresponding to the thickness 42 of the engineered board 38 and adhered to one another in a stack in a direction along the width 44 of the engineered board, as shown in FIG. 4.

It will be noted that because the sawing is done in a direction generally perpendicular to growth rings of the individual pieces of lumber on average, most of the knots are on faces of the individual pieces, and are thus hidden. The remaining knots 46 which are exposed on the wide faces 48, 50 of the engineered board 38, are generally aligned across the thickness 52 of the individual pieces 40a, 40b, 40c . . . 40n, and will thus likely be sawn along a portion of their length, which provides an original and appealing visual appearance when contemplating the exposed wide faces 48, 50 of the engineered board 38.

Alternately to sawing in the direction transverse to the adhered faces of the individual pieces, one can obtain engineered boards by sawing in the direction parallel to the adhered faces. The engineered boards obtained can be four by four posts, or similar configurations, for example. In fact, it was found that by adhering the faces to one another rather than the sides, the adhesive can penetrate into the lumber around the knots and hold the knots in place, allowing subsequent transformation. Still alternately, the stack can be planed and thereafter be used as a whole, without subsequent sawing.

Henceforth, the example described above and illustrated is intended to be exemplary only. The scope is indicated by the appended claims.

What is claimed is:

1. A process of making engineered boards of spruce wood, the process comprising:
obtaining a plurality of lumber boards of spruce wood having same dimensions, each of said lumber boards having a length greater than a width, and the width greater than a thickness, the thickness extending between two faces, and a moisture content equal to or below a threshold moisture content of 12%, the thickness of the lumber boards on average extending in a direction perpendicular to an average growth ring direction and parallel to an average knot direction;
adhering the lumber boards face to face into a stack having a thickness corresponding to the width of the lumber boards;
obtaining engineered boards of spruce wood by sawing the stack.

2. The process of claim 1, wherein the sawing is done perpendicularly across the faces of the adhered lumber boards.

3. The process of claim 1 wherein said obtaining a plurality of boards includes planing both faces of dimensional lumber boards having the same dimensions.

4. The process of claim 3 wherein said obtaining a plurality of boards further includes drying said dimensional lumber boards.

5. The process of claim 4, wherein said obtaining a plurality of boards further includes measuring the moisture content of the boards subsequently to said drying, and submitting the boards to further drying if the measured moisture content is not below the threshold moisture content.

6. The process of claim 4 wherein said drying occurs prior to said planing.

7. The process of claim 1 wherein the threshold moisture content is 10%.

8. The process of claim 1 wherein the threshold moisture content is 8%.

9. An engineered board having a length greater than a width, and a width greater than a thickness, including a plurality of individual pieces of lumber each having the thickness of the engineered board and adhered to one in a direction of the width of the engineered board into a stack, the engineered board being CHARACTERIZED IN THAT the direction of the width of the engineered board is perpendicular to an average growth ring direction and parallel to an average knot direction.

10. The engineered board of claim 9 further characterized in that the lumber is Black spruce wood.

11. The engineered board of claim 9 further characterized in that the moisture content of the individual pieces of lumber is equal to or below 12%.

12. The engineered board of claim 11 wherein the moisture content is equal to or below 10%

13. The engineered boards of claim 12 wherein the moisture content is equal to or below 8%.

14. The engineered board of claim 9 provided in the form of a cabinetwork product.
